(19) United States
(12) Patent Application Publication
(10) Pub. No.: US 2025/0136782 A1
(43) Pub. Date: May 1, 2025

(54) CARBON BLACK FROM NATURAL GAS

(71) Applicant: Monolith Materials, Inc., Lincoln, NE (US)

(72) Inventors: Ned J. HARDMAN, Woodside, CA (US); Roscoe W. Taylor, San Mateo, CA (US); Alexander F. Hoermann, Menlo Park, CA (US); Peter L. Johnson, Mountain View, CA (US); Christopher J.-P. Cardinal, Sunnyvale, CA (US); Robert J. Hanson, San Carlos, CA (US)

(21) Appl. No.: 18/680,456

(22) Filed: May 31, 2024

Related U.S. Application Data
(63) Continuation of application No. 18/381,881, filed on Oct. 19, 2023, now abandoned.
Application No. 18/381,881 is a continuation of application No. 18/172,835, filed on Feb. 22, 2023, now abandoned.
Application No. 18/172,835 is a continuation of application No. 17/862,242, filed on Jul. 11, 2022, now abandoned.
Application No. 17/862,242 is a continuation of application No. 17/529,928, filed on Nov. 18, 2021, now abandoned.
Application No. 17/529,928 is a continuation of application No. 17/239,041, filed on Apr. 23, 2021, now abandoned.
Application No. 17/239,041 is a continuation of application No. 17/021,197, filed on Sep. 15, 2020, now abandoned.
Application No. 17/021,197 is a continuation of application No. 15/262,539, filed on Sep. 12, 2016, now Pat. No. 10,808,097.
(60) Provisional application No. 62/218,137, filed on Sep. 14, 2015.

(51) Int. Cl. C08K 3/04; C01B 32/15; C08J 5/00; C09C 1/48; C09C 1/50

(52) U.S. Cl. CPC C08K 3/04; C01B 32/15; C08J 5/005; C09C 1/485; C01P 2002/77; C01P 2004/04; C01P 2004/32; C01P 2004/61; C01P 2004/62; C01P 2004/64; C01P 2006/12; C01P 2006/19; C01P 2006/80; C08J 2321/00; C08K 2201/003; C08K 2201/011; C09C 1/50

(57) ABSTRACT

Carbon nanoparticles made in a one step process. A method of making carbon black nanoparticles is described, including adding a hydrocarbon to a heated gas to produce carbon nanoparticles that are less than 1 micron volume equivalent sphere and have an Lc greater than 3.0 nm. Elastomer composites containing such particles are also described.

### TECHNICAL FIELD

The field of art to which this invention generally pertains is methods and apparatus for making use of electrical energy to affect chemical changes.

### BACKGROUND

There are many processes that can be used and have been used over the years to produce carbon black. The energy sources used to produce such carbon blacks over the years have, in large part, been closely connected to the raw materials used to convert hydrocarbon containing materials into carbon black. Residual refinery oils and natural gas have long been a resource for the production of carbon black. Energy sources have evolved over time in chemical processes such as carbon black production from simple flame, to oil furnace, to plasma, to name a few. As in all manufacturing, there is a constant search for more efficient and effective ways to produce such products, and new and improved products. Varying flow rates and other conditions of energy sources, varying flow rates and other conditions of raw materials, increasing speed of production, increasing yields, reducing manufacturing equipment wear characteristics, etc. have all been, and continue to be, part of this search over the years.

The embodiments described herein meet the challenges described above, and additionally attain more efficient and effective manufacturing process.

### BRIEF SUMMARY

Carbon nanoparticles are described including carbon nanoparticles that are less than 1 micron volume equivalent sphere and have an Lc greater than 3.0 nanometers (nm).

Additional embodiments include: the carbon nanoparticle described above where the volume equivalent sphere is less than 700 nm; the carbon nanoparticle described above where the d002 is less than 0.35 nm; the carbon nanoparticles described above including a fullerene-like surface structure; the carbon nanoparticle described above where the particles have 0.2% hydrogen or less by weight as produced; the carbon nanoparticles described above where the particles have 0.4% oxygen or less by weight as produced; the carbon nanoparticles described above where the particles have 0.3% sulfur or less by weight as produced.

Elastomer composites containing the carbon nanoparticles described above compounded therein and additionally containing sulfur, are also described.

Additional embodiments include: the composite described above where the strain required to stretch the elastomer composite 300% of the original length is at least 90% of the reference carbon black elastomer composite value; the composite described above where the tan delta at 0° C. is at least 90% of the reference carbon black elastomer composite value; the composite described above where the tan delta at 60° C. is less than 110% of the reference carbon black elastomer composite value; the composite described above where the tan delta at 60° C. is less than 95% of the reference carbon black elastomer composite value.

A method of making carbon nanoparticles in a one step process is also described including adding a hydrocarbon to a heated gas to produce carbon nanoparticles that are less than 1 micron volume equivalent sphere and have an Lc greater than 3.0 nm.

Additional embodiments include: the method described above where the hydrocarbon has been mixed with a hot gas to effect removal of hydrogen from the hydrocarbon; the method described above where the nanoparticles are produced in an oxygen free atmosphere; the method described above where the hydrocarbon is natural gas; the method described above where the yield of carbon nanoparticles is at least 90%; the methods described above additionally including the use of one or more heat exchangers, filters, degas chambers, and/or backend equipment; the method described above where the backend equipment includes one or more of a pelletizer, a binder mixing tank connected to the pelletizer, and/or a dryer connected to the pelletizer.

These and additional embodiments are further described below.

### BRIEF DESCRIPTION OF THE DRAWINGS

FIG. 1 demonstrates a flow chart of a process described herein.

FIGS. 2, 3 and 4 depict various apparatus for carrying out processes described herein.

FIGS. 5 and 6 show typical Transmission Electron Micrograph (TEM) images of carbon nanoparticle produced by processes herein.

### DETAILED DESCRIPTION

The particulars shown herein are by way of example and for purposes of illustrative discussion of the various embodiments of the present invention only and are presented in the cause of providing what is believed to be the most useful and readily understood description of the principles and conceptual aspects of the invention. In this regard, no attempt is made to show details of the invention in more detail than is necessary for a fundamental understanding of the invention, the description making apparent to those skilled in the art how the several forms of the invention may be embodied in practice.

The present invention will now be described by reference to more detailed embodiments. This invention may, however, be embodied in different forms and should not be construed as limited to the embodiments set forth herein. Rather, these embodiments are provided so that this disclosure will be thorough and complete, and will fully convey the scope of the invention to those skilled in the art.

Unless otherwise defined, all technical and scientific terms used herein have the same meaning as commonly understood by one of ordinary skill in the art to which this invention belongs. The terminology used in the description of the invention herein is for describing particular embodiments only and is not intended to be limiting of the invention. As used in the description of the invention and the appended claims, the singular forms “a,” “an,” and “the” are intended to include the plural forms as well, unless the context clearly indicates otherwise. All publications, patent applications, patents, and other references mentioned herein are expressly incorporated by reference in their entirety.

Unless otherwise indicated, all numbers expressing quantities of ingredients, reaction conditions, and so forth used in the specification and claims are to be understood as being modified in all instances by the term “about.” Accordingly, unless indicated to the contrary, the numerical parameters set forth in the following specification and attached claims are approximations that may vary depending upon the desired properties sought to be obtained by the present invention. At the very least, and not as an attempt to limit the application of the doctrine of equivalents to the scope of the claims, each numerical parameter should be construed in light of the number of significant digits and ordinary rounding approaches.

Notwithstanding that the numerical ranges and parameters setting forth the broad scope of the invention are approximations, the numerical values set forth in the specific examples are reported as precisely as possible. Any numerical value, however, inherently contains certain errors necessarily resulting from the standard deviation found in their respective testing measurements. Every numerical range given throughout this specification will include every narrower numerical range that falls within such broader numerical range, as if such narrower numerical ranges were all expressly written herein.

Additional advantages of the invention will be set forth in part in the description which follows, and in part will be obvious from the description, or may be learned by practice of the invention. It is to be understood that both the foregoing general description and the following detailed description are exemplary and explanatory only and are not restrictive of the invention, as claimed.

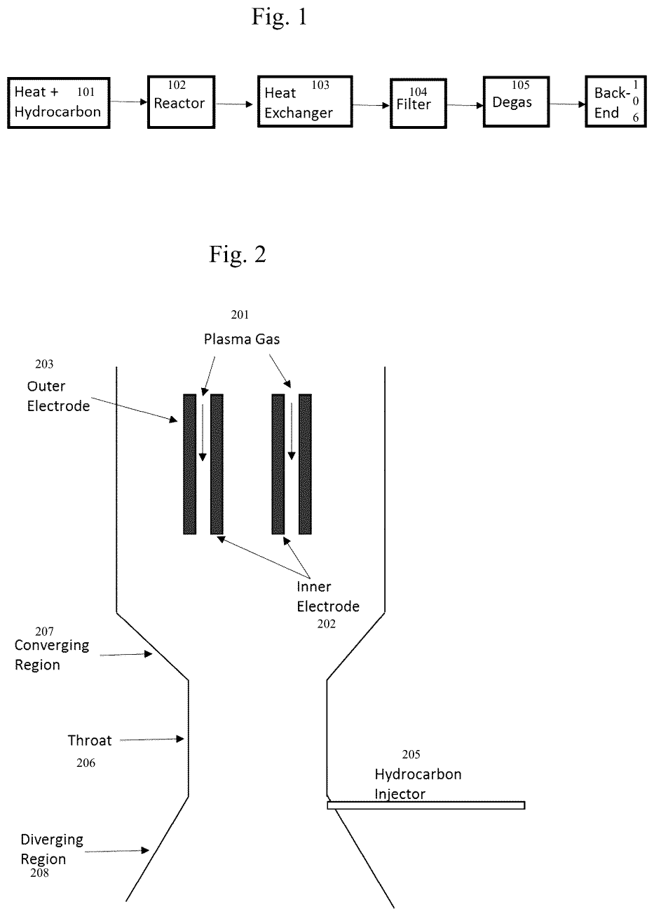

FIG. 1 shows that the process begins through the addition of hydrocarbon to hot gas. FIGS. 2, 3 and 4 show different methods of combining the hot gas and the hydrocarbon precursor. The hot gas is typically a stream of hot gas that is at an average temperature of over 2200° C. The hot gas will typically be comprised of greater than 50% hydrogen by volume.

The hydrocarbon feedstock used include any chemical within the formula CₙHₓ or CₙHₓO_{y}, where n is an integer, x is between 1n and 2n+2, and y is between 0 and n. For example, simple hydrocarbons such as methane, ethane, propane, butane, etc. can be used. Aromatic feedstocks such as benzene, toluene, methyl naphthalene, pyrolysis fuel oil, coal tar, coal, heavy oil, oil, bio-oil, bio-diesel, other biologically derived hydrocarbons, or the like can be used. Also, unsaturated hydrocarbon feedstocks can also be used, such as ethylene, acetylene, butadiene, styrene and the like. Oxygenated hydrocarbons such as ethanol, methanol, propanol, phenol, ketones, ethers, esters, and similar compounds are also acceptable feedstocks. The above should be viewed as non-limiting examples of acceptable hydrocarbon feedstocks which can additionally be combined and/or mixed with other acceptable components. The use of the term hydrocarbon feedstock herein, refers to feedstocks where the majority of the feedstock is hydrocarbon in nature. For example, natural gas would be a preferred hydrocarbon feedstock for the processes described herein.

Heat can also be provided through latent radiant heat from the wall of the reactor. This can either occur through heating of the walls via an external energy source or through the heating of the walls from the hot gas. The heat is transferred from the hot gas to the hydrocarbon feedstock. This will occur immediately upon addition of the hydrocarbon feedstock to the hot gas in the reactor or the reaction zone (102). The hydrocarbon will begin to crack and decompose before being fully converted into carbon black.

The process described herein is substantially free of atmospheric oxygen. The process is designed to include heating a gas that is comprised of 50% or greater by volume hydrogen and then adding this hot gas to a hydrocarbon (101). The process includes one or more of the steps of heating the gas, adding hydrocarbon to the hot gas, and can additional include the use of one or more of a heat exchanger (103), filter (104), degas chamber (105), and backend (106). The backend can optionally include one or more of a pelletizer, a binder mixing tank connected to the pelletizer, and a dryer connected to the pelletizer. These components are shown schematically in FIG. 1. With the exception of the degas unit, conventional pieces of equipment used in the carbon black industry to perform these functions can be used, as demonstrated, for example, by U.S. Pat. Nos. 3,981,659; 3,309,780; and 3,307,923, the disclosures of which are herein incorporated by reference. The degas unit which can be used is also described in commonly assigned, copending U.S. provisional patent application Ser. No. 62/111,346, Carbon Black Generating System, the entirety of which is incorporated by reference herein.

FIG. 2 shows a schematic representation of an embodiment of a typical apparatus described herein. Plasma gas (201) such as oxygen, nitrogen, argon, helium, air, hydrogen, carbon monoxide, hydrocarbon (e.g. methane, ethane) etc. (used alone or in mixtures of two or more) is injected into an annulus created by two electrodes that are positioned in the upper chamber in a concentric fashion. Plasma forming electrodes are arranged with an inner (202) and outer (203) electrode and a sufficiently large voltage is applied between the two electrodes. Electrodes are typically made of copper, tungsten, graphite, molybdenum, silver etc. The thus-formed plasma then enters into the reaction zone where it reacts/interacts with a hydrocarbon feedstock that is fed at the hydrocarbon injector (205) to generate a carbon black product. The walls of the vessel can withstand the plasma forming temperatures, with graphite being the preferred material of construction. And the hydrocarbon injector(s) (205) can be located anywhere on a plane at or near the throat (206) below the converging region (207) or further downstream of the throat in the diverging region (208) of the reactor. The hydrocarbon injector tips are arranged concentrically around the injection plane and there can be at least 6 injectors and up to 18 tips of this sort, or a slot, as non-limiting examples.

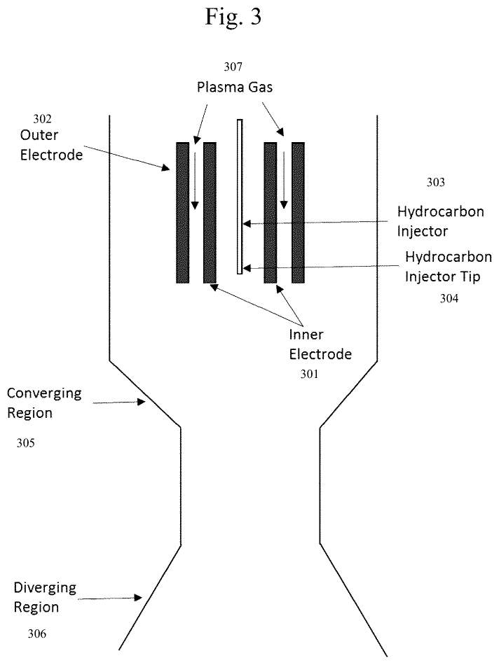

FIG. 3 shows another embodiment of a typical apparatus described herein. This is a two dimensional cutout of a reactor that utilizes inner (301) and outer electrodes (302) that consist of concentric rings of electrically conductive material, preferably graphite. Plasma gas (307) can flow through the annulus between the two electrodes where the arc will then excite the gas into the plasma state. The arc is controlled through the use of a magnetic field which moves the arc in a circular fashion rapidly around the electrode tips. In this example, the hydrocarbon is injected at the hydrocarbon injector (303) tip (304) through the center of the concentric electrodes via a hydrocarbon injector that can be optionally water cooled. The hydrocarbon injector tip can be placed to a point above the bottom plane of the electrodes, or it can be below the plane, or at the same height as the plane. Optionally, there are converging regions (305) leading to a narrowing of the reactor and then diverging regions (306) downstream of the converging region.

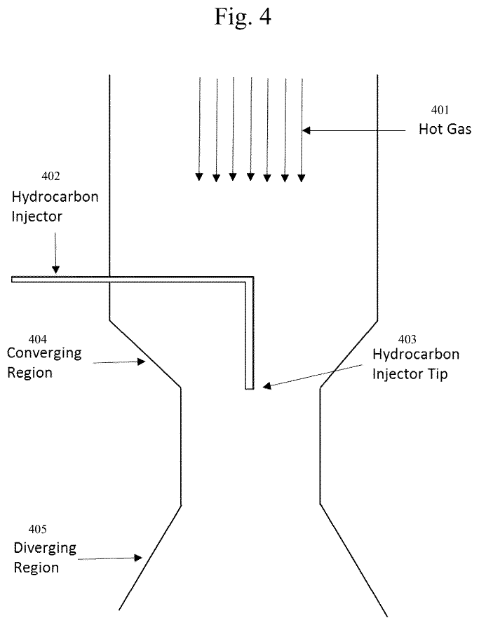

FIG. 4 shows another embodiment of an apparatus described herein. Hot gas is generated in the upper portion of the reactor either through the use of three or more AC electrodes, through the use of concentric DC electrodes as shown in FIGS. 2 and 3, or through the use of a resistive heater, more detail of which can be found in commonly assigned, copending U.S. Patent Application Ser. No. 62/209,017, High Temperature Heat Integration Method Of Making Carbon Black, the disclosure of which is herein incorporated by reference. The hot gas (401) is comprised of at least 50% hydrogen by volume that is at least 2400° C. The hydrocarbon injector (402) can be water cooled and enters from the side of the reactor and then turns into an axial position in regard to hot gas flow. The hydrocarbon injector tip (403) can be one opening or a plurality of openings that can inject hydrocarbons in clockwise or counter clockwise flow patterns to optimize mixing. Optionally, there are converging regions (404) leading to a narrowing of the reactor and then diverging regions (405) downstream of the converging region.

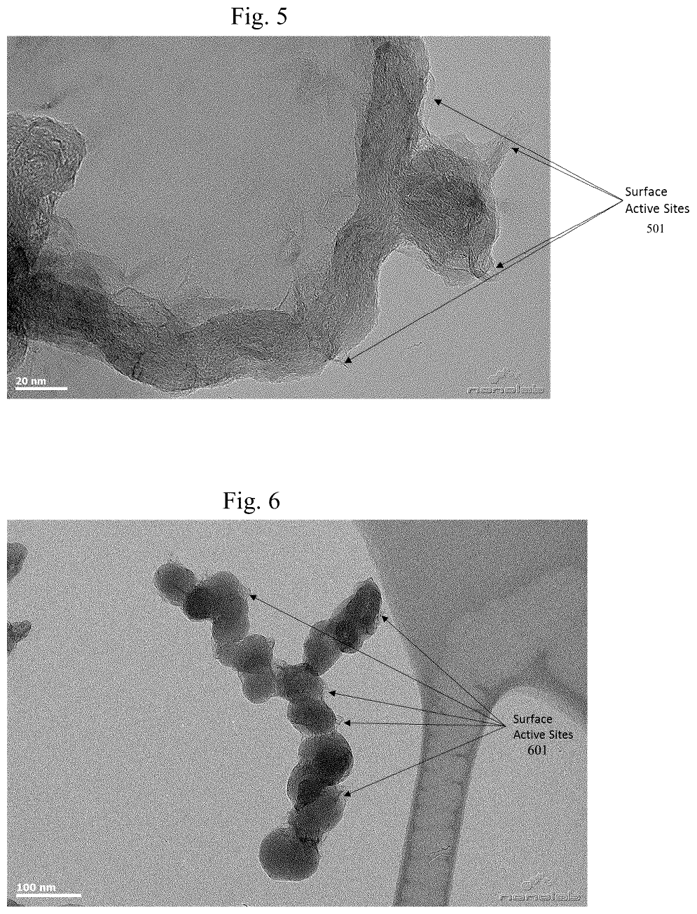

FIGS. 5 and 6 are Transmission Electron Micrograph (TEM) images of typical carbon nanoparticle produced by the above processes. The surface active sites (501 and 601) are unique to these high temperature techniques and are not found in furnace carbon black samples. Only some representative surface active sites are labelled.

In its early years, carbon black was made from oil and tar via the lamp or thermal process. In the mid-19th century, the channel process which utilized the impingement of natural gas on hot iron channels became the main method of manufacture of carbon black. In the early 1940s, the furnace process came to the forefront which utilizes a heavy oil such as pyrolysis fuel oil (PFO) to manufacture carbon black in an oxygen lean combustion environment at carbon yields of approximately 40-50%.

Plasma based synthesis of carbon black utilizing natural gas has both cost and pollution reducing advantages over the furnace process. The process is clean, emitting near zero local CO₂, and zero SOₓ-compared to multiple tons of CO₂ for the furnace process, with tens of kilograms of NOₓ and SOₓ for every ton of carbon black produced. Although the plasma technique has been attempted many times throughout the last century, there have been no long term viable commercial production enterprises based on this process.

A one step process as described herein contains the reactants and products up until a degas step has been completed to remove the hydrogen that has been produced from the cracking of, for example, methane. Hydrogen is a highly combustible gas and must be separated from the as-produced carbon nanoparticles in order to manipulate the carbon nanoparticles. A degas is considered to be complete if the hydrogen level has been reduced to less than 20 percent by volume.

An oxygen free atmosphere is deemed to possess less than 5% oxygen by volume for the examples stated herein. Preferably, the oxygen free atmosphere is less than 3% or less than 1% oxygen.

In the past, plasma generator designs have not been able to meet the power, corrosion resistance, and continuous operation requirements to produce carbon black because of such things as the insufficient unit power of their basic components and the tendency of these components to decay when exposed to hydrogen plasma, resulting in lost reactor time, increased capital costs, and uneconomically produced carbon black, among other things. For more details concerning methods of heating hydrocarbons rapidly to form carbon nanoparticles and hydrogen please see the following commonly assigned, copending U.S. patent applications, the disclosures of which are herein incorporated by reference: Ser. No. 62/111,317, Carbon Black Combustible Gas Separation; Ser. No. 14/591,541, Use Of Feedstock In Carbon Black Plasma Process; Ser. No. 14/601,761, Plasma Gas Throat Assembly And Method; Ser. No. 14/601,793, Plasma Reactor; Ser. No. 62/198,431, DC Plasma Torch Electrical Power Design Method And Apparatus; Ser. No. 14/591,528, Integration Of Plasma And Hydrogen Process With Combined Cycle Power Plant, Simple Cycle Power Plant, And Steam Reformer; Ser. No. 62/202,498, Method Of Making Carbon Black; Ser. No. 14/610,299, Plasma Torch Design; Ser. No. 14/591,476, System For High Temperature Chemical Processing; Ser. No. 62/198, 486, Method Of Making Carbon Black Including Thermal Transfer Gas; Ser. No. 62/111,341, Regenerative Cooling Method And Apparatus.

In addition, there have never been satisfactory rubber performance results of carbon nanoparticles produced in a plasma. When compounded into rubber, plasma based carbon nanoparticles have been substandard in performance when compared to furnace based carbon black. This is part of the reason that plasma produced carbon nanoparticles have never been adopted and mass produced. The processes and systems described herein can successfully generate quality carbon nanoparticles that can reinforce elastomer compounds.

Elastomer as defined herein refers to a class of polymers that are related to natural rubber that have both viscous and elastic components or viscoelasticity. Some example elastomers are natural rubber (NR), styrene butadiene rubber (SBR), polybutadiene, polyisobutylene, polyisoprene, nitrile rubber, ethylene propylene rubber (EPM), ethylene propylene diene rubber (EPDM), silicone rubber, fluoroelastomers, amongst other classes that can be found in “The Science and Technology of Rubber” (Mark, Erman, and Roland, Fourth Edition, Academic Press, @2013).

Reinforcement of elastomer is defined as an increase in tensile strength, tear resistance, abrasion resistance, and modulus to increase beyond the values expected from simple particle-matrix theory. In other words, the carbon nanoparticle, be it carbon black or some other carbon nanoparticle, enables the stiffening of the gummy elastomer so that it can be more useful in applications such as tires, door seals, rubber hoses, etc.

A carbon nanoparticle is any particle which is 90% or greater carbon, has a surface area greater than 5 m²/g (square meters per gram), and the volume equivalent sphere possesses a diameter of less than 1 micron (displacement of liquid is equivalent to a 1 micron sphere or less per particle). This can be comprised of many different shapes including disks, bowls, cones, aggregated disks, few layer graphene (FLG), ellipsoidal, aggregated ellipsoidal, spheres, and aggregated spheres (e.g. carbon black), as non-limiting examples. The carbon nanoparticles can also comprise a plurality of these particle shapes. When using the definition of carbon nanoparticles, it is assumed that at least 90% of the particles in any given sample on a number basis fall within the confines of this definition.

Dibutyl phthalate (DBP) absorption measures the relative structure of carbon black by determining the amount of DBP a given mass of carbon black can absorb before reaching a specified viscous paste. Thermal blacks have the lowest DBP numbers (32-47 ml/100 g) (milliliters per gram) of any carbon black, indicating very little particle aggregation or structure. DBP is typically measured by following ASTM D2414-12. The nitrogen surface area (N2SA) and statistical thickness surface area (STSA) are measured via ASTM D6556-10.

Crystallinity of the carbon nanoparticle can be measured via X-Ray Crystal Diffractometry (XRD). Specifically for the measurements described herein, Cu K alpha radiation is used at a voltage of 40 kV (kilovolts) and a current of 44 mA (milliamps). The scan rate is 1.3 degrees/minute from 2 theta equal 12 to 90 degrees. The 002 peak of graphite is analyzed using the Scherrer equation to obtain Lc (lattice constant) and d002 (the lattice spacing of the 002 peak of graphite) values reported herein. Briefly, larger Lc values correspond to greater degree of crystallinity. Smaller lattice spacing (d002) values correspond to higher crystallinity or a more graphite like lattice structure. Larger lattice spacing (d002) of 0.36 nm or larger is indicative of turbostratic carbon which is common for carbon black samples produced via the furnace process. Elemental analysis is measured via devices manufactured by Leco and the results are given as percentage of the total sample.

Styrene butadiene rubber specimens were prepared according to ASTM D3191. ASTM D412 and ASTM D2240 were utilized to measure tensile properties and Shore A Hardness. Tangent delta was measured using TA Instruments RSA G2 device at a temperature range of −100 C to 100 C at a heating rate of 4 C/minute a strain of 0.5% and a frequency of 10 Hz.

TABLE 1
Physical Characteristics of Samples.

| | N2SA | STSA | DBP | Lc | d002 | | | | |
|---|---|---|---|---|---|---|---|---|---|
| Name | (m2/g) | (m2/g) | (mL/100 g) | (nm) | (nm) | S | H | N | O |
| N234 | 121 | 119 | 124 | 2.2 | 0.366 | 1.05 | 0.32 | 0.23 | 1.75 |
| N234 | 125 | 130 | 118 | 2.9 | 0.358 | 0.70 | 0.03 | 0.08 | 0.2 |
| @1200 | | | | | | | | | |
| N550 | 38.8 | 38.4 | 120 | 2.5 | 0.359 | 2.10 | 0.27 | 0.12 | 0.87 |
| N762 | 26.2 | 25.6 | 65 | 2.6 | 0.358 | 1.57 | 0.26 | 0.08 | 0.52 |
| M762 | 24.5 | 26.5 | 70 | 6.8 | 0.347 | 0.13 | 0.09 | 0.16 | 0.16 |
| M550 | 45.6 | 48.8 | 135 | 6.9 | 0.346 | 0.15 | 0.09 | 0.2 | 0.11 |

TABLE 2
Elastomer composite performance values.

| | | Tensile | Elongation | Durometer |
|---|---|---|---|---|
| | 300% | Strength | at Break | Shore |
| Name | (psi) | (psi) | (%) | Hardness |
| N234 | 3265 | 3507 | 326 | 75 |
| N234 | 1235 | 3036 | 589 | 68 |
| @1200C | | | | |
| N762 | 1527 | 2870 | 496 | 63 |
| M762 | 1547 | 2609 | 437 | 64 |
| N550 | 2101 | 3161 | 450 | 58 |
| M550 | 2136 | 3033 | 401 | 58 |

TABLE 3
Tan delta values for elastomer composites.

| | Tan | Tan | Tan |
|---|---|---|---|
| | Delta | Delta | Delta |
| Sample | 60° C. | 40° C. | 0° C. |
| N762 | 0.1197 | 0.1329 | 0.1745 |
| M762 | 0.1106 | 0.1226 | 0.1747 |
| N550 | 0.1416 | 0.1553 | 0.2028 |
| M550 | 0.1325 | 0.1456 | 0.1995 |

Samples of competitor grades of N234, N550, and N762 carbon blacks were obtained. These samples were made via the furnace process with a heavy oil. N234 was heat treated in an inert atmosphere at 1200° C. and is labelled in the tables as “N234 @1200 C”. M550 and M762 are designations given to Monolith carbon nanoparticles produced via mixing hot gas with natural gas as described herein.

### Example 1: Manufacture of M762

Samples were manufactured using a setup similar to that shown in FIG. 3 where a hydrocarbon injector is inserted into the center of two concentric electrodes. The injector tip is 14 inches above the plane of the electrodes and the electrodes are operating at 650 kW. The plasma temperature was 2900° C. and the fully mixed reaction temperature was 2100° C. The hydrogen flow rate in the annulus between the electrodes was 90 Nm³/hr (normal cubic meters/hour) and the shield flow around the outside of the electrodes was 242 Nm³/hr. Natural gas was injected at a rate of 88 kg/hour. Yield of carbon nanoparticles based upon methane conversion rate was greater than 95%.

### Example 2: Manufacture of M550

Samples were manufactured using a setup similar to that shown in FIG. 3 where a hydrocarbon injector is inserted into the center of two concentric electrodes. The injector tip is 14 inches above the plane of the electrodes and the electrodes are operating at 850 kW. The plasma temperature was 2900° C. and the fully mixed reaction temperature was 2100° C. The hydrogen flow rate in the annulus between the electrodes was 235 Nm³/hr (normal cubic meters/hour) and the shield flow around the outside of the electrodes was 192 Nm³/hr. Natural gas was injected at a rate of 103 kg/hour. Yield of carbon nanoparticles based upon methane conversion rate was greater than 94%.

Typical carbon black as currently made by the furnace process is made in a very similar fashion worldwide. Variation in hydrogen content, oxygen content, sulfur content and crystallinity is very minimal between different plants and different manufacturers. Grades are determined by the N2SA and by the DBP values. Only very minor differences can be determined due to differences in surface activity or crystallinity as all of the furnace blacks are very similar in these characteristics. Reference carbon black is a carbon black material as made in the furnace process that has values of N2SA and DBP within 20% of the carbon nanoparticles produced by the process described herein. In Table 1, the specific values of the reference furnace carbon black (labelled with “N” prefix) can be found and compared to the experimental grades that are labelled with an “M” prefix.

The importance of crystallinity and surface activity is paramount as can be seen in the examples from Tables 1 and 2. Through the heat treatment of N234 to only 1200° C., the reinforcement capability of the carbon black has been completely eliminated. The hydrogen content is lower and the crystallinity is higher. Both of these factors point to lower performance of the carbon black as a reinforcing agent according to various literature sources (for example, “The Science and Technology of Rubber” cited above and “Carbon Black Elastomer Interaction” Rubber Chemistry and Technology, 1991, pages 19-39—the disclosures of which both are herein incorporated by reference).

Specifically, the modulus at 300% has decreased from 3265 psi to 1235 psi (pounds per square inch). The elongation at break has increased from 326% to 589% indicating that the rubber composite test specimen with the heat treated N234 behaves almost as though there were no carbon black filler present. The specimen is not stiff and behaves as the raw rubber gum would behave in terms of ability to stretch and force required to pull the specimen to 3 times the original length. The increased crystallinity, decreased d002, decreased hydrogen content all point to a less active surface, even though the N2SA and DBP are almost unchanged. The composites also typically contain about 0.5% to about 4% by weight sulfur.

For Monolith samples, even though the crystallinity is more than double that of the furnace black counterpart, the hydrogen content is one-third that of the furnace black counterpart and there is more than 10 times less sulfur present, the samples reinforce rubber quite well.

This is a surprising result that runs counterintuitive to current thought in carbon black reinforcement science. One possibility to these strong results is the existence of “fullerene-like” moieties in the carbon black produced in the process described herein. These types of surface active species are observed in FIGS. 5 and 6. For more information about fullerene like moieties, please see “The Impact of a Fullerene-Like Concept in Carbon Black Science”, Carbon, 2002, pages 157-162—the disclosure of which is incorporated by reference herein. In this paper it is proposed to radiate already manufactured carbon black with plasma gas, however, it was not conceived to be possible until now that fullerene-like moieties (referred to as “surface active sites” (501 and 601) in FIGS. 5 and 6) could be manufactured in one step from a hydrocarbon precursor.

Increasing tan delta at 0° C. correlates to improved wet traction, while lowering tan delta at 60° C. correlates to improved rolling resistance. Generally, conventional tread rubber compounds that optimize tan delta at one temperature negatively impact tan delta at the other temperature. It is therefore surprising that the M550 and M762 (given above in Table 3) show the same performance for tan delta at 0° C. and improved performance at 60° C. when compared to reference furnace carbon black. This should correspond to better rolling resistance in tire tread grades of carbon black while maintaining wet grip performance.

Thus, the scope of the invention shall include all modifications and variations that may fall within the scope of the attached claims. Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

1.-19. (canceled)

20. Carbon nanoparticles, wherein the carbon nanoparticles have a volume equivalent sphere diameter of less than 1 micrometer (μm), a lattice constant (Lc) greater than 3.0 nanometers (nm), and a sulfur content of 0.3% or less by weight.

21. The carbon nanoparticles of claim 20, wherein the volume equivalent sphere diameter is less than 700 nm.

22. The carbon nanoparticles of claim 20, wherein a lattice spacing of a 002 peak of graphite (d002) of the carbon nanoparticles is less than 0.35 nm.

23. The carbon nanoparticles of claim 20, wherein the carbon nanoparticles comprise a fullerene-like surface structure.

24. The carbon nanoparticles of claim 20, wherein the carbon nanoparticles have a hydrogen content of 0.2% or less by weight.

25. The carbon nanoparticles of claim 20 wherein the carbon nanoparticles have an oxygen content of 0.4% or less by weight.

26. The carbon nanoparticles of claim 20, wherein the carbon nanoparticles have a carbon content of at least 90% by weight.

27. The carbon nanoparticles of claim 20, wherein the carbon nanoparticles have a surface area of at least 5 square meters per gram (m²/g).

28. The carbon nanoparticles of claim 20, wherein the carbon nanoparticles comprise disks, bowls, cones, aggregated disks, few layer graphene (FLG), ellipsoidal particles, aggregated ellipsoidal particles, spheres, or aggregated spheres.

29. The carbon nanoparticles of claim 20, wherein the carbon nanoparticles are carbon black.

30. Carbon nanoparticles, wherein the carbon nanoparticles have a volume equivalent sphere diameter of less than 1 micrometer (μm), a lattice spacing of a 002 peak of graphite (d002) of less than 0.35 nanometers (nm), and a sulfur content of 0.3% or less by weight.

31. The carbon nanoparticles of claim 30, wherein the carbon nanoparticles have a surface area of at least 5 square meters per gram (m²/g), a hydrocarbon content of 0.2% or less by weight, an oxygen content of 0.4% or less by weight, and a carbon content of at least 90% by weight.

32. The carbon nanoparticles of claim 30, wherein the volume equivalent sphere diameter is less than 700 nm.

33. The carbon nanoparticles of claim 30, wherein the carbon nanoparticles were produced by cracking a hydrocarbon in an atmosphere of less than 5% oxygen by volume.

34. The carbon nanoparticles of claim 30, wherein the carbon nanoparticles are carbon black.

35. Carbon nanoparticles, wherein the carbon nanoparticles have a volume equivalent sphere diameter of less than 1 micrometer (μm) and a lattice constant (Lc) greater than 3.0 nanometers (nm), and wherein the carbon nanoparticles are configured to reinforce an elastomer compound.

36. The carbon nanoparticles of claim 35, wherein the carbon nanoparticles are configured to reinforce the elastomer compound by increasing one or more of a tensile strength, a tear resistance, an abrasion resistance, a modulus, or a stiffness of the elastomer compound.

37. The carbon nanoparticles of claim 35, wherein the elastomer compound comprises natural rubber (NR), styrene butadiene rubber (SBR), polybutadiene, polyisobutylene, polyisoprene, nitrile rubber, ethylene propylene rubber (EPM), ethylene propylene diene rubber (EPDM), silicone rubber, fluoroelastomer, or any combination thereof.

38. The carbon nanoparticles of claim 35, wherein the carbon nanoparticles are carbon black and have a nitrogen surface area (N2SA) and a dibutyl phthalate (DBP) absorption within 20% of a comparative N2SA and a comparative DBP absorption, respectively, of a comparative furnace carbon black.

39. The carbon nanoparticles of claim 35, wherein the carbon nanoparticles were produced by cracking a hydrocarbon in an atmosphere of less than 5% oxygen by volume.
